(19) United States
(12) Patent Application Publication
(10) Pub. No.: US 2012/0133659 A1
(43) Pub. Date: May 31, 2012

(54) METHOD AND APPARATUS FOR PROVIDING STATIC FRAME

(75) Inventors: Andjelija Masnikosa, Richmond Hill (CA); Collis Quinn Carter, Richmond Hill (CA)

(73) Assignee: ATI TECHNOLOGIES ULC, Markham (CA)

(21) Appl. No.: 12/956,740

(22) Filed: Nov. 30, 2010

(51) Int. Cl. G06F 13/14; G06T 15/00

(52) U.S. Cl. 345/520; 345/522

(57) ABSTRACT

A method and apparatus provides for providing a static frame. In one example, the method and apparatus divides a frame into regions and sends the divided regions of the frame from a display data transmitter, e.g., a processor such as a graphic processing unit (GPU), to a display data receiver, e.g., a timing controller (TCON). In a self-refresh mode when the frame is static, the method and apparatus detects alteration of one or more regions in the static frame. The alteration may be due to data errors in one or more regions of the static frame captured by the display data receiver and/or due to updated content (e.g., movement of a cursor) in one or more regions of the static frame in the display data transmitter. The method and apparatus then, in one example, only resends those altered regions from the display data transmitter to the display data receiver to redress the alteration.

### BACKGROUND OF THE DISCLOSURE

The disclosure relates generally to a methods and apparatus for providing a static frame for display on a display device.

Systems for processing and displaying graphics usually include a graphic sub-system such as a graphic processing unit (GPU) for providing display data and a display device for presenting display content. The display device usually includes or couples to a controller such as a timing controller (TCON) that acts as an interface and controller for a display panel of the display device. For example, the TCON receives display data from the GPU with control instructions, and controls writing of pixels and directs operations of the display panel. In order to reduce power consumption of the system, when no graphic processing activity and/or lack of update to the frame buffer have been detected for a period of time, both the GPU and the TCON may enter a self-refresh mode that includes powering down one or more components, capturing the current frame from the GPU as a static frame, and repeatedly outputting the captured static frame to the display panel for display.

In the self-refresh mode, the static frame is captured from a frame buffer of the graphic sub-system to the TCON and is stored in a static frame buffer of the TCON for display. The captured static frame in the TCON needs to be updated if data errors occur in the captured static frame due to data transmission and/or storage errors, or if the content of the static frame in the frame buffer of the graphic sub-system has been changed since capturing.

In responding to these situations, some known systems update the static frame by resending the entire static frame from the graphic sub-system to the TCON. For example, some known systems may apply a cyclic redundancy check (CRC) to the received static frame by the TCON to detect data errors. If one or more data errors are detected, the graphic sub-system then resends the entire static frame, even if the errors occur only in a small portion of the static frame. Likewise, if only a small portion of the static frame has been updated by the graphic sub-system, the known systems may still resend the entire static frame to the TCON to update the static frame stored in the TCON. Consequently, power is wasted in known systems.

Additionally, in known systems when the image as changed, the graphics sub-system transmits an entire new frame to the TCON. Only when the frame in the TCON is determined to have become static, does the graphics sub-system enter in a reduced power mode. This occurs regardless of the magnitude of the difference between the initial static frame and the frame newly generated by the graphics sub-system.

Accordingly, there exists a need for an improved method and apparatus for providing a static frame.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram illustrating one example of an apparatus for providing a static frame;

FIG. 2 is a flowchart illustrating one example of a method for providing a static frame;

FIG. 3 is a flowchart illustrating one example of the method for providing a static frame shown in FIG. 2 in accordance with one embodiment set forth in the disclosure;

FIG. 4 is a block diagram illustrating one example of a display data transmitter of the apparatus for providing a static frame shown in FIG. 1 in accordance with one embodiment set forth in the disclosure;

FIG. 5 is a block diagram illustrating one example of a display data receiver of the apparatus for providing a static frame shown in FIG. 1 in accordance with one embodiment set forth in the disclosure;

FIGS. 6 and 7 are flowcharts illustrating one example of the method for providing a static frame shown in FIG. 3 in accordance with one embodiment set forth in the disclosure;

FIG. 8 is a block diagram illustrating another example of a display data transmitter of the apparatus for providing a static frame shown in FIG. 1 in accordance with one embodiment set forth in the disclosure;

FIG. 9 is a block diagram illustrating another example of a display data receiver of the apparatus for providing a static frame shown in FIG. 1 in accordance with one embodiment set forth in the disclosure;

FIGS. 10 and 11 are flowcharts illustrating another example of the method for providing a static frame shown in FIG. 3 in accordance with one embodiment set forth in the disclosure;

FIG. 12 is a block diagram illustrating one example of the apparatus for providing a static frame shown in FIG. 1 in accordance with one embodiment set forth in the disclosure;

FIGS. 13 and 14 are flowcharts illustrating another example of the method for providing a static frame shown in FIG. 2 in accordance with one embodiment set forth in the disclosure; and

FIG. 15 is an illustration of one example of a plurality of regions of a frame.

### DETAILED DESCRIPTION OF THE PREFERRED EMBODIMENTS

Briefly, in one example, a method and apparatus for providing a static frame divides a frame into regions and sends the divided regions of the frame from a display data transmitter, e.g., a processor such as a graphic processing unit (GPU), to a display data receiver, e.g., a timing controller (TCON). In a self-refresh mode when the frame is static, the method and apparatus detects alteration of one or more regions in the static frame. The alteration may be due to data errors in one or more regions of the static frame captured by the display data receiver and/or due to updated content (e.g., movement of a cursor) in one or more regions of the static frame in the display data transmitter. The method and apparatus then, in one example, only resends those altered regions from the display data transmitter to the display data receiver to redress the alteration.

Among other advantages, the method and apparatus provides the ability to reduce power consumption of a graphic processing and display system. Only the altered regions that contain data errors and/or updated content, as opposed to the complete static frame, need to be resent from the display data transmitter to the receiver in the self-refresh mode. Accordingly, the display data transmitter and receiver may further reduce their power consumption and enter the deep power saving mode faster compared with the known systems.

In one example embodiment, one or more regions of the static frame are altered due to data errors. The method and apparatus generates associated expected error-checking information for each divided region. For example, the expected error-checking information may be an error-checking code such as but not limited to a cyclic redundancy check (CRC) code or any suitable error-checking information for detecting data errors due to data transmission and/or storage errors. The method and apparatus also determines at least one region of the static frame to send again in response to an error-checking result indicating the at least one altered region based on the expected error-checking information and actual error-checking information. The actual error-checking information may be, for example, generated for each received region of the static frame by the display data receiver using the same coding scheme for generating the expected error-checking information. The actual error-checking information from the display data receiver may be compared with the expected error-checking information from the display data transmitter to provide the error-checking result. The error-checking result indicates whether an error occurs for each region of the static frame. The method and apparatus then sends the determined at least one region of the static frame again from the display data transmitter to the display data receiver.

In one example, the method and apparatus may also send frame divide information from the display data transmitter to the display data receiver. The frame divide information indicates a manner in which the static frame is divided into the plurality of regions. The frame divide information may include, for example, a start coordinate, a size of each block, or any other suitable information.

The error-checking result may be provided by either the display data receiver or by the display data transmitter. In one example, the error-checking result is provided by the display data receiver. The method and apparatus sends the plurality of regions of the static frame with associated expected error-checking information from the display data transmitter to the display data receiver. In this example, the method and apparatus then provides, by the display data receiver, the error-checking result in response to comparing the expected error-checking information with the actual error-checking information for each region of the static frame. The error-checking result is then sent to the display data transmitter.

In another example, the error-checking result is provided by the display data transmitter. The method and apparatus sends the actual error-checking information from the display data receiver to the display data transmitter. The method and apparatus then provides, by the display data transmitter, the error-checking result in response to comparing the expected error-checking information with the actual error-checking information for each region of the static frame.

If the error-checking result indicates that no error occurs for all the plurality of regions of the static frame, the method and apparatus may output the static frame to for display. For example, the display data receiver may output a static frame without errors in all of its regions to a display panel for display.

In another example embodiment, one or more regions of the static frame are altered due to updated content. The method and apparatus detects at least one updated region of the plurality of regions of the static frame at the display data transmitter, wherein data is updated in the at least one updated region. In one example, a new static frame may be written into the frame buffer and cause data of one or more regions of the previous static frame to update. In another example, movement of a mouse cursor may cause data of one or more regions that are on the cursor moving path to update. In response to the detection of the at least one updated region, the method and apparatus sends the at least one updated region of the static frame from the display data transmitter to replace the corresponding regions of the static frame stored in the display data receiver.

The method and apparatus may also send updated region identification information from the display data transmitter to the display data receiver. The updated region identification information identifies the at least one updated region in the static frame. The updated region identification information may, for example, include a start coordinate, a size of each updated block, or any other suitable information. The method and apparatus may replace data in at least one of the plurality of received regions with data in the at least one corresponding updated region based on the updated region identification information. The method and apparatus may output the static frame with the updated regions to a display panel for display.

Among other advantages, the method and apparatus provides the ability to reduce power consumption of a graphic processing and display system. Only the altered regions that contain data errors and/or updated content, as opposed to the complete static frame, need to be resent from the display data transmitter to the receiver in the self-refresh mode. Accordingly, the display data transmitter and receiver may further reduce their power consumption and enter the deep power saving mode faster compared with the known systems. In addition, the method and apparatus may perform the data error-checking by either the display data transmitter or by the display data receiver. The region based error-checking result is not limited to be provided at the transmitter side or at the receiver side, thereby increasing the design flexibility and compatibility for implementing such feature. Other advantages will be recognized by those of ordinary skill in the art.

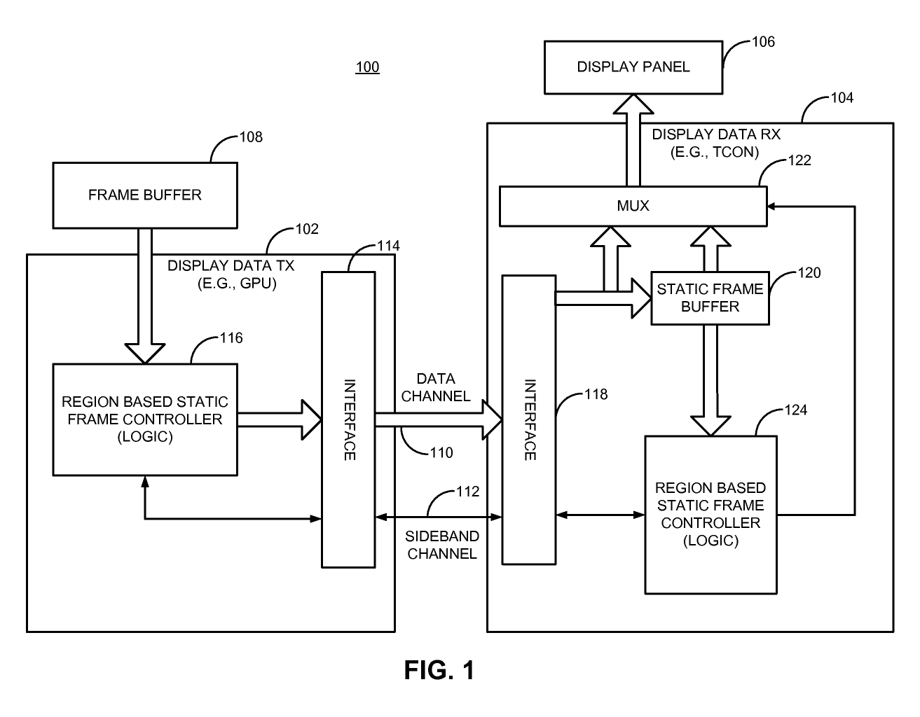

FIG. 1 illustrates one example of an apparatus 100 for providing a static frame. The apparatus 100 may be any suitable device, for example, a laptop computer, desktop computer, media center, handheld device (e.g., mobile or smart phone, tablet, etc.), Blu-ray™ player, gaming console, set top box, printer, or any other suitable device. In this example, the apparatus 100 will be described as a computer system such as a laptop computer. The apparatus 100 may include a display data transmitter 102, a display data receiver 104, and a display panel 106. In this example, the apparatus 100 may also include a frame buffer 108 that is operatively coupled to the display data transmitter 102. In other examples, the frame buffer 108 may be part of the display data transmitter 102. The display data receiver 104 is operatively coupled to the display data transmitter 102 through a plurality of communication links such as a data channel 110 (also known as a main link) for transmitting at least display data and a bi-directional sideband channel 112 (also known as an auxiliary (AUX) channel in the DisplayPort standard) for transmitting control and/or status signals. The display data receiver 104, in this example, is also operatively coupled to the display panel 106 to output display frames to the display panel 106. It is understood that any other suitable component may also be included in the apparatus 100.

The display data transmitter 102 may be, for example, a graphic processor (e.g., GPU), a general processor (e.g., APU, accelerated processing unit; GPGPU, general-purpose computing on GPU), or any other suitable processor. The display data transmitter 102 may also be a stand-alone integrated circuit that is operatively coupled to one or more processors or coupled to any suitable display system. In this example, the display data transmitter 102 includes an interface 114 for communicating with the display data receiver 104. The interface 114 may send display data such a dynamic or static frame through the data channel 110 and transmit control and/or status signals through the sideband channel 112. The interface 114 may be, for example, a display connector, such as but not limited to a digital display connector, for example, DisplayPort, HDMI, mini-DVI, micro-DVI, OpenLDI, to name a few, a wireless connector, or any other suitable connector.

The display data transmitter 102 also includes logic 116 operatively coupled to the interface 114 and the frame buffer 108. The “logic” referred to herein may be any suitable hardware, executing firmware, executing software module, or any suitable combination thereof that can perform the desired function, such as programmed processors, discrete logic, for example, state machine, to name a few. In this example, the logic 116 may be any suitable circuit that can achieve the desired function, such as a digital circuit, an analog circuit, a mixed analog-digital circuit, or any other suitable circuit. The logic 116 is operative to divide a frame in the frame buffer 108 into a plurality of regions and control the interface 114 to send the divided regions to the display data receiver 104. The logic 116 is also operative to control the interface 114 to, in a self-refresh mode, send at least one region of the frame corresponding to at least one altered region of the static frame to the display data receiver 104. The altered static frame regions are determined to have data errors and/or updated content. As shown in FIG. 1, the logic 116 may fetch one or more regions of the frame from the frame buffer 108 to the interface 114. The logic 116 may also control and monitor the operations of the interface 114 by control and/or status signals.

The display data receiver 104 of the apparatus 100 may be, for example, any suitable controller (e.g., timing controller, TCON) for receiving the display data from the display data transmitter 102 with control instructions and controlling writing of pixels and directing operations of the display panel 106. The display data receiver 104 may also be a video capture device, a hub, a repeater, a wireless radio device, a protocol translator, or any suitable data receiver. In this example, the display data receiver 104 includes an interface 118 for communicating with the display data transmitter 102. The interface 118 is operative to receive display data such a dynamic or static frame through the data channel 110 and transmit control and/or status signals through the sideband channel 112. The interface 118 may be, for example, a display connector, such as but not limited to a digital display connector, for example, DisplayPort, HDMI, mini-DVI, micro-DVI, OpenLDI, to name a few, a wireless connector, or any other suitable connector.

The display data receiver 104 may also include a static frame buffer 120 and a multiplexer (MUX) 122. The static frame buffer 120 is operatively coupled to the interface 118 and the MUX 122. In a normal mode, the display data transmitter 102 continuously sends dynamic frames to the interface 118 of the display data receiver 104. The display data receiver 104 then controls the MUX 122 to output the dynamic frames from the interface 118 directly to the display panel 106. In a self-refresh mode, the display data transmitter 102 sends a static frame to the display data receiver 104. In response to receiving the static frame by the interface 118, the static frame buffer 120 stores the static frame, and the MUX 122 outputs the static frame from the static frame buffer 120 instead of outputting the dynamic frame from the interface 118 directly. In the self-refresh mode, the static frame stored in the static frame buffer 120 is outputted to the display panel 106 repeatedly, and thus, the data channel 110 can be disabled to reduce power consumption.

In this example, the display data receiver 104 also includes logic 124 operatively coupled to the interface 118, the static frame buffer 120, and the MUX 122. The “logic” referred to herein may be any suitable hardware, executing firmware, executing software module, or any suitable combination thereof that can perform the desired function, such as programmed processors, discrete logic, for example, state machine, to name a few. In this example, the logic 124 may be any suitable circuit that can achieve the desired function, such as a digital circuit, an analog circuit, a mixed analog-digital circuit, or any other suitable circuit. The logic 124 may fetch one or more regions of the static frame from the static frame buffer 120. The logic 124 may also control and monitor the operations of the interface 118 and the MUX 122 by control and/or status signals. When one or more regions of the static frame are altered due to data errors, the logic 124 is operative to generate actual error-checking information for each received region of the static frame to determine whether an error occurs in each region; and when one or more regions of the static frame are altered due to updated content, the logic 124 is operative to replace data in the original regions with data in the corresponding updated regions.

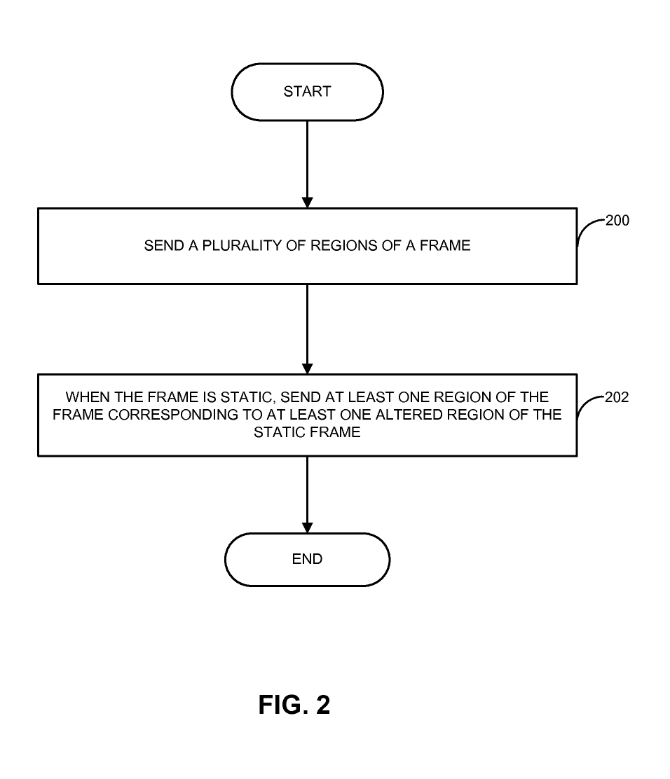

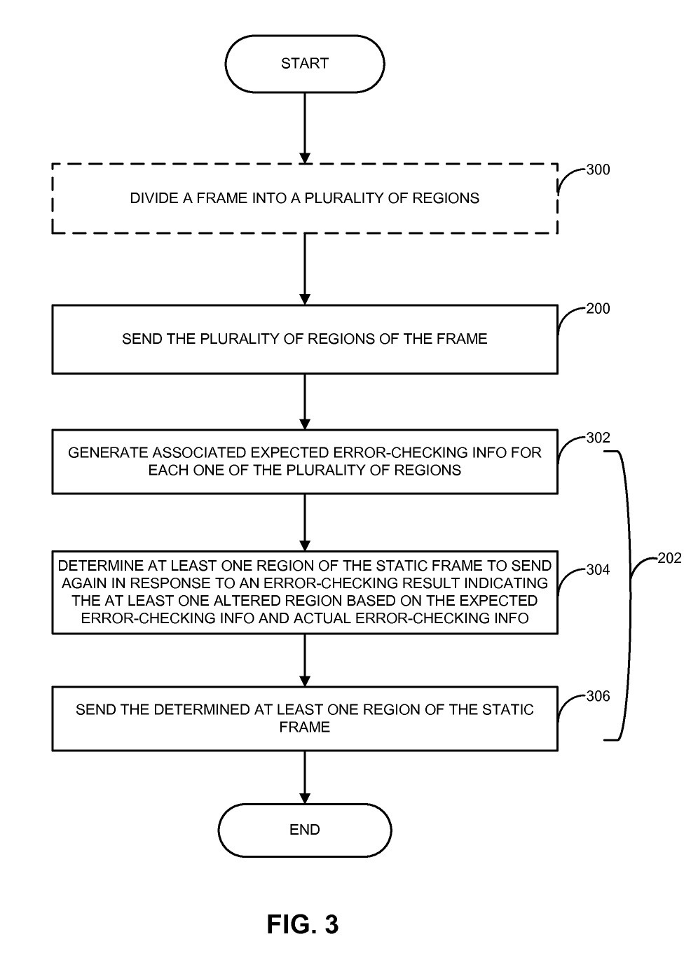

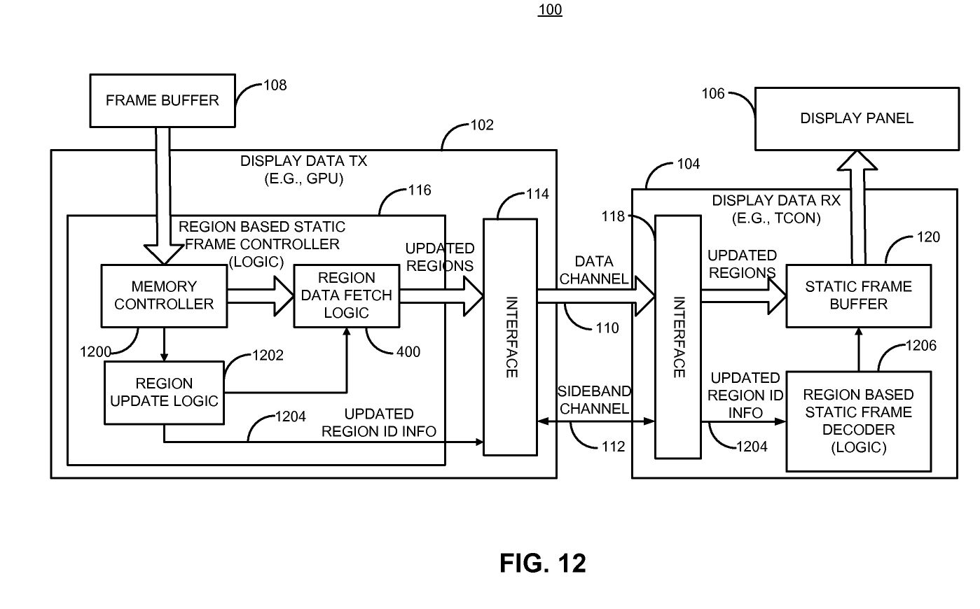

FIG. 2 illustrates one example of a method for providing a static frame. It will be described with reference to FIG. 1. However, any suitable logic or structure may be employed. In operation, the logic 116 of the display data transmitter 102, at block 200, controls the interface 114 of the display data transmitter 102 to send a plurality of regions of a frame to the display data receiver 104. In a self-refresh mode when the frame is static, at block 202, the logic 116 controls the interface 114 to send at least one region of the frame to the display data receiver 104 corresponding to at least one altered region of the static frame. The static frame region may have been altered due to data errors (as described more fully with respect to FIGS. 3-11) and/or due to changes in the data to be displayed (i.e., updated content, as described more fully with respect to FIGS. 12-14).

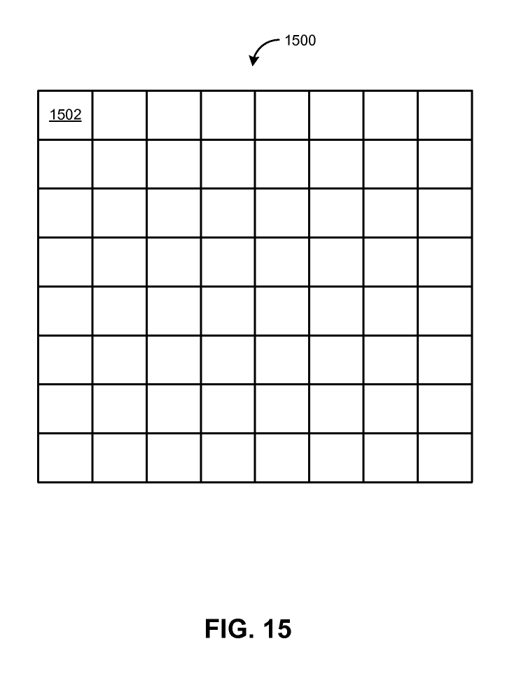

FIG. 3 illustrates one example of a method for providing a static frame when one or more regions of the static frame are altered due to data errors. It will be described with reference to FIG. 1. However, any suitable logic or structure may be employed. In order to send the plurality regions of the frame, optionally at block 300, the logic 116 of the display data transmitter 102 may first divide the frame into a plurality of regions. In one example, also referring to FIG. 15, a frame 1500 stored in the frame buffer 108 is fetched by the logic 116 and divided equally into a plurality of blocks 1502. Each block 1502 may be identified by a start coordinate and a size of the block 1502. A frame 1500 is presented as a plurality of pixels, (e.g., 1920 by 1080 pixels) on the display panel 106, and each pixel is stored in the frame buffer 108 in a multi-bits format (e.g., 24-bit). Thus, the start coordinate and the size of each block 1502 may be represented by pixels, register numbers, memory addresses, memory offsets, or any suitable combination thereof. In other examples, the frame may be divided equally into a plurality of lines (also known as slices), triangles, or any other suitable regions. It is also understood that each region may not be divided equally if desired. As the frame is divided by the logic 116 of the display data transmitter 102, frame divided information that indicates a manner in which the frame is divided into the plurality of regions may be provided to the display data receiver 104. It is understood that, the frame may be divided following a predefined rule that is also known by the display data receiver 104. In that situation, the frame divided information may not be necessary to be provided to the display data receiver 104.

Referring back to FIG. 3, at block 200, the logic 116 controls the interface 114 of the display data transmitter 102 to send the plurality of regions of the frame to the display data receiver 104 through the data channel 110. For example, when the apparatus 100 enters a self-refresh mode, the frame in the frame buffer 108 is a static frame, and the display data transmitter 102 sends all the regions of the first static frame to the display data receiver 104 for display.

At block 302, the logic 116 generates associated expected error-checking information for each one of the plurality of regions. The logic 116 may generate a number of check bits (or parity data), which are derived from the data bits of each region by a deterministic algorithm. The expected error-checking information is generated based on the data bits of each region at the display data transmitter 102 side. The expected error-checking information is used to be compared with actual error-checking information generated based on the data bits of each region received by the display data receiver 104 in order to determine whether there is a mismatch between the expected and actual error-checking information. The expected and actual error-checking information is derived by the same coding scheme and may be, for example, cyclic redundancy check (CRC) codes, repetition codes, parity bits, checksums, hash functions, to name a few. In particular, the expected and actual error-checking information is derived based on the data bits of each region of the static frame, as opposed to the complete static frame.

Proceeding to block 304, the logic 116 determines at least one region of the static frame to send again in response to an error-checking result indicating the at least one altered region based on the expected error-checking information and actual error-checking information. As previously explained, data errors in each region of the static frame caused by transmission and/or storage of the static frame can be detected by comparing the expected and actual error-checking information for each region. The error-checking result indicates whether an error occurs for each region of the static frame, and thus, can be used by the logic 116 to determine which one or more regions need to be resent in order to correct the errors in the static frame stored in the display data receiver 104. It is noted that, although the determining process of block 304 is performed by the logic 116 of the display data transmitter 102, the error-checking result may be provided by either the logic 116 of the display data transmitter 102 or by the logic 124 of the display data receiver 104. At block 306, the logic 116 controls the interface 114 to send the determined one or more regions to the display data receiver 104 to replace the corresponding altered regions that have data errors.

Although the processing blocks illustrated in FIG. 3 are illustrated in a particular order, those having ordinary skill in the art will appreciate that the processing can be performed in different orders. For example, block 200 can be performed after block 302 or performed essentially simultaneously. The logic 116 may send the plurality of regions of the frame to the display data receiver 104 after generating the expected error-checking information if desired.

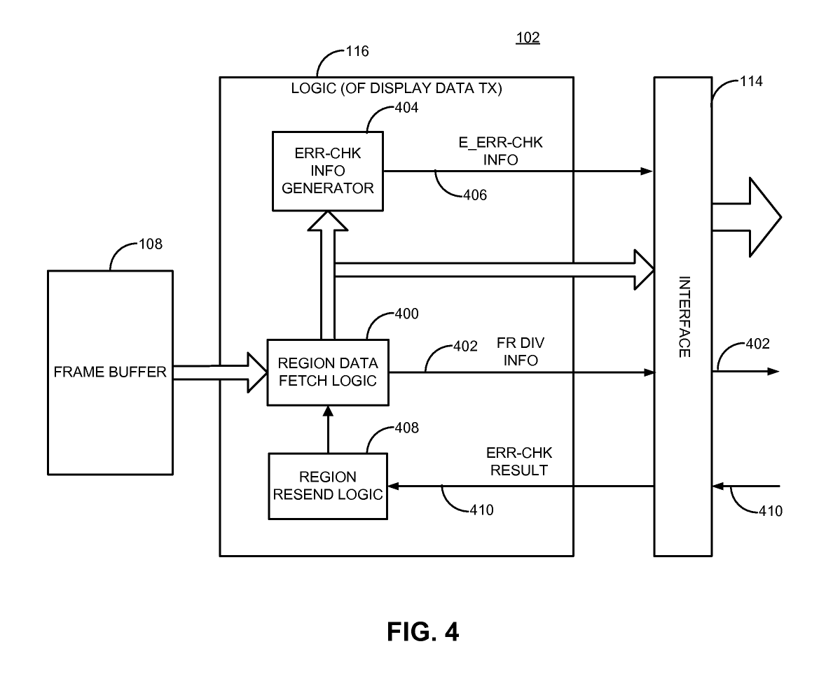

FIG. 4 is a block diagram illustrating one example of the display data transmitter 102 of the apparatus 100 for providing a static frame when one or more regions of the static frame are altered due to data errors. In this example, the logic 116 of the display data transmitter 102 includes region data fetch logic 400 operatively coupled to the frame buffer 108 and the interface 114. The region data fetch logic 400 is operative to fetch the static frame from the frame buffer 108 and divide the static frame into a plurality of regions. The region data fetch logic 400 may be further operative to provide the frame divide information 402 and control the interface 114 to send the frame divide information 402 to the display data receiver 104 through the sideband channel 112 if necessary. In this example, the logic 116 also includes an error-checking information generator 404 operatively coupled to the region data fetch logic 400 and the interface 114. The error-checking information generator 404 is operative to receive the divided regions of the static frame from the region data fetch logic 400 and generate the expected error-checking information 406 for each region. Preferably, the error-checking information generator 404 may be a CRC generator that generates an expected CRC code based on the data bits of each region.

In this example, the region data fetch logic 400 is further operative to control the interface 114 to send the divided regions of the static frame to the display data receiver 104 through the data channel 110; and the error-checking information generator 404 is also operative to control the interface 114 to send the associated expected error-checking information 406 with the regions of the static frame through the data channel 110. In order to associate expected error-checking information 406 to its corresponding region, the error-checking information generator 404 may control the interface 114 to send the two types of data (i.e., display data and error-checking information) in various manners. In one example, all the expected error-checking information 406 may be packed together and sent after the entire static frame. Pointers or tables may be used to link expected error-checking information 406 to its corresponding region. In another example, expected error-checking information 406 may be sent immediately after its corresponding region. It is also understood that, although it is preferred to send the expected error-checking information 406 through the data channel 110 with the regions of the static frame, the expected error-checking information 406 may also be sent through the sideband channel 112 if desired.

The logic 116 in this example also includes region resend logic 408 operatively coupled to the region data fetch logic 400 and the interface 114. When the error-checking result 410 is received by the interface 114 from the display data receiver 104, the region resend logic 408 is operative to determine which one or more regions need to be resent based on the received error-checking result 410. The region resend logic 408 is further operative to provide the determination to the region data fetch logic 400; and the region data fetch logic 400 is further operative to control the interface to resend those regions that are determined by the region resend logic 408 through the data channel 110 to the display data receiver 104.

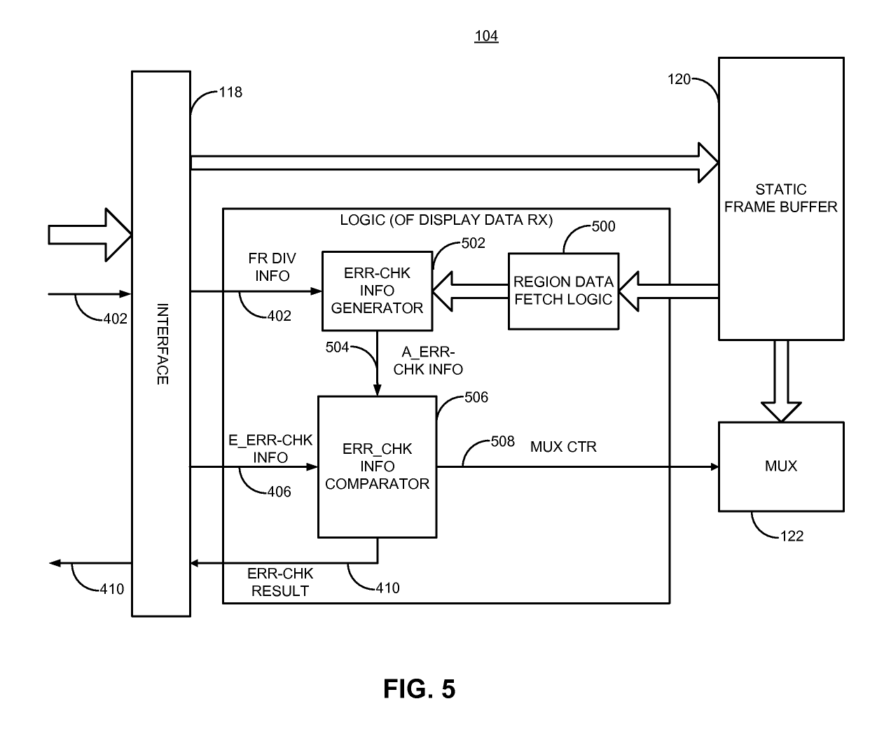

FIG. 5 is a block diagram illustrating one example of the display data receiver 104 of the apparatus 100 for providing a static frame when one or more regions of the static frame are altered due to data errors. In this example, the interface 118 of the display data receiver 104 is operative to receive the regions of the static frame and transfer the received regions to the static frame buffer 120 for storage. The logic 124 of the display data receiver 104 includes region data fetch logic 500 operatively coupled to the static frame buffer 120. The region data fetch logic 500 is operative to fetch the stored regions of the static frame from the static frame buffer 120. In this example, the logic 124 includes an error-checking information generator 502 operatively coupled to the region data fetch logic 500 and the interface 118. Similar to the error-checking information generator 404 in the display data transmitter 102, the error-checking information generator 502 is operative to generate the actual error-checking information 504 for each received region of the static frame. As previously explained, if the static frame is not divided following a predefined rule that is known by the display data receiver 104, then the frame divide information 402 is necessary for the error-checking information generator 502 to identify the data bits for each region and generate the associated actual error-checking information 504 for each region. Otherwise, the frame divide information 402 is not needed by the error-checking information generator 502.

In this example, the logic 124 further includes an error-checking information comparator 506 operatively coupled to the error-checking information generator 502 and the interface 118. The error-checking information comparator 506 is operative to receive the actual error-checking information 504 from the error-checking information generator 502 and the expected error-checking information 406 from the display data transmitter 102 through the interface 118. The error-checking information comparator 506 is further operative to compare the expected error-checking information 406 with the actual error-checking information 504 for each region to decide whether there is a mismatch between the error-checking information 406, 504. As the error-checking information 406, 504 for the same region of the static frame is derived by the same coding scheme, the mismatch indicates that data errors occur in that specific region of the static frame. After comparing the error-checking information 406, 504 for all the regions, the error-checking information comparator 506 is operative to provide the error-checking result 410 that specifies each region that has data errors, and is operative to control the interface 118 to send the error-checking result 410 to the display data transmitter 102.

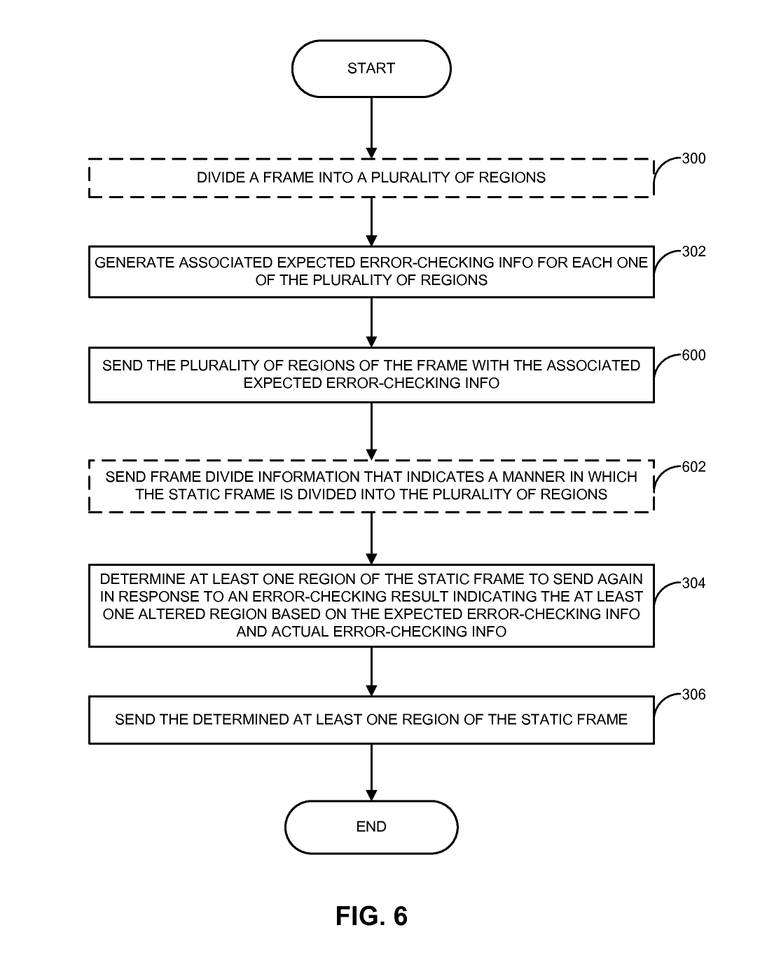

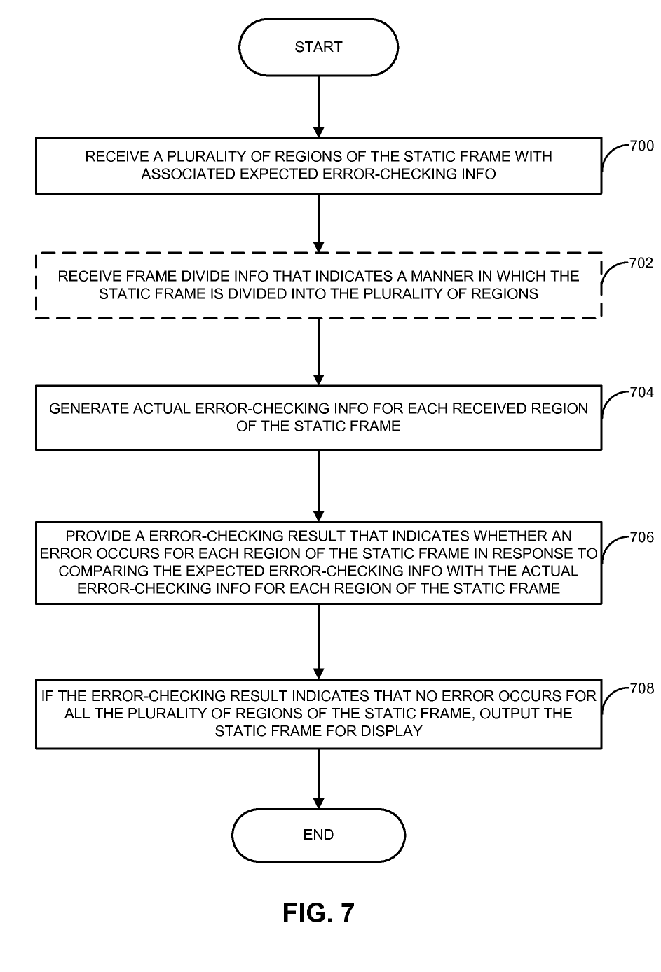

FIGS. 6 and 7 illustrate an example of a method for providing a static frame when one or more regions of the static frame are altered due to data errors. It will be described with reference to FIGS. 1, 4, and 5. However, any suitable logic or structure may be employed. In this example, the region based error-checking result is provided by the display data receiver 104 as shown in FIG. 5. In operation, as shown in FIG. 6, the region data fetch logic 400 of the display data transmitter 102, at block 300, may divide the frame into a plurality of regions if necessary. The error-checking information generator 404 of the display data transmitter 102 then generates associated expected error-checking information for each region at block 302.

In this example, in addition to sending the plurality of regions of the frame, at block 600, the error-checking information generator 404 of the display data transmitter 102 controls the interface 114 to send the divided regions of the frame with the associated expected error-checking information 406 to the display data receiver 104 through the data channel 110. For example, when the apparatus 100 enters a self-refresh mode, the frame in the frame buffer 108 is a static frame, and the display data transmitter 102 sends all the regions of the first static frame to the display data receiver 104 for display with the associated expected error-checking information 406. Optionally at block 602, the region data fetch logic 400 may also control the interface 114 to send the frame divide information 402 to the display data receiver 104 through the sideband channel 112 depending on whether the regions are divided following a predefined rule that is known by the display data receiver 104.

In response, as shown in FIG. 7, the interface 118 of the display data receiver 104 receives the plurality of regions of the static frame with associated expected error-checking information 406 from the display data transmitter 102 at block 700. Optionally, the interface 118 may also receive the frame divide information 402 from the display data transmitter 102 at block 702.

Proceeding to block 704, the error-checking information generator 502 of the display data receiver 104 generates the actual error-checking information 504 for each received region of the static frame using the same coding scheme (e.g., deterministic algorithm) for generating the expected error-checking information 406 at block 302. If the display data receiver 104 does not know how the regions are divided from the static frame, the frame divide information 402 may be necessary to generate the actual error-checking information 504 for each received region. It is understood that as data errors may occur due to the data transmission errors, the storage errors, or both, block 704 may be performed periodically after receiving the static frame by the display data receiver 104. In one example, the actual error-checking information 504 for each region is generated immediately after receiving the regions to determine whether data errors happen due to the transmission. In another example, the actual error-checking information 504 for each region is periodically generated after being stored in the static frame buffer 120 to determine whether data errors occur due to the storage errors.

Further to block 706, the error-checking information comparator 506 provides the error-checking result 410 that indicates whether an error occurs for each region of the static frame in response to comparing the expected error-checking information 406 with the actual error-checking information 504 for each region of the static frame. The error-checking result 410 is sent to the display data transmitter 102 to notify the display data transmitter 102 which one or more regions of the static frame stored in the display data receiver 104 contain data errors and need to be resent.

Referring back to FIG. 6, at block 304, the region resend logic 408 of the display data transmitter 102 determines at least one region of the static frame to send again in response to the error-checking result 410 as the static frame region has been altered. At block 306, the region data fetch logic 400 controls the interface 114 to send the determined regions of the static frame to the display data receiver 104 to replace the corresponding altered regions stored in the static frame buffer 120.

It is understood that one or more processing blocks in FIGS. 6 and 7 may be performed again to determine whether all the data errors have been corrected after resending. The process may finish if the error-checking result 410 indicates that no error occurs for all the plurality of regions of the static frame. Eventually, at block 708 in FIG. 7, the error-checking information comparator 506 of the display data receiver 104 may send a MUX control signal 508 to control the MUX 122 to output the stored static frame to the display panel 106 for display.

Although the processing blocks illustrated in FIGS. 6 and 7 are illustrated in a particular order, those having ordinary skill in the art will appreciate that the processing can be performed in different orders. For example, block 600 can be performed after block 602 or performed essentially simultaneously. The interface 114 may simultaneously, or in any suitable order, send the regions of the static frame, the associated expected error-checking information 406, and the frame divide information 402 to the display data receiver 104.

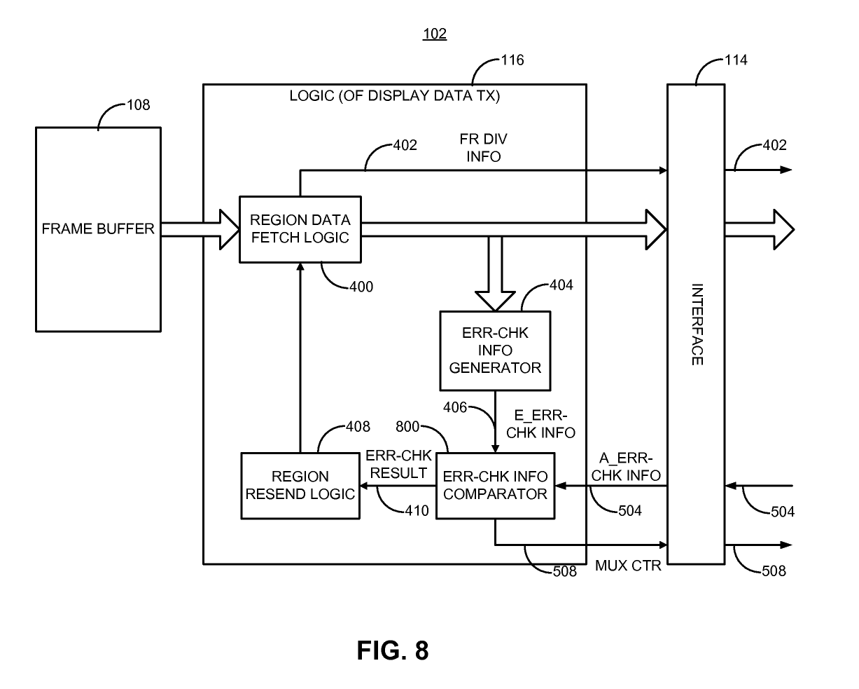

FIG. 8 is a block diagram illustrating another example of the display data transmitter 102 of the apparatus 100 for providing a static frame when one or more regions of the static frame are altered due to data errors. Similar to the display data transmitter 102 described above with respect to FIG. 4, in this example, the display data transmitter 102 also includes the region data fetch logic 400, the error-checking information generator 404, and the region resend logic 408. Compared with the example embodiment illustrated in FIG. 4, the display data transmitter 102 in FIG. 8 further includes an error-checking information comparator 800 operatively coupled to the error-checking information generator 404, the region resend logic 408, and the interface 114. The error-checking information generator 404 in this example does not control the interface 114 to send the expected error checking information 406 to the display data receive 104. Instead, the error-checking information generator 404 is operative to provide the expected error checking information 406 to the error-checking information comparator 800 in the display data transmitter 102. The error-checking information comparator 800 is also operative to receive the actual error-checking information 504 from the display data receiver 104 and provide the error-checking result 410 to the region resend logic 408 based on the comparison of the expected and actual error-checking information 406, 504. In addition, the error-checking information comparator 800 is operative to generate the MUX control signal 508 if no error occurs for all the regions of the static frame based on the comparison, and is operative to control the interface 114 to send the MUX control signal 508 to the display data receiver 104. Accordingly, unlike FIG. 4 in which the display data transmitter 102 has to send the expected error-checking information 406 to the display data receiver 104 and reply on the error-checking result 410 from the display data receiver 104; in this example, the display data transmitter 102 includes the error-checking information comparator 800, so that it can generate the error-checking result 410 internally without sending out the expected error-checking information 406.

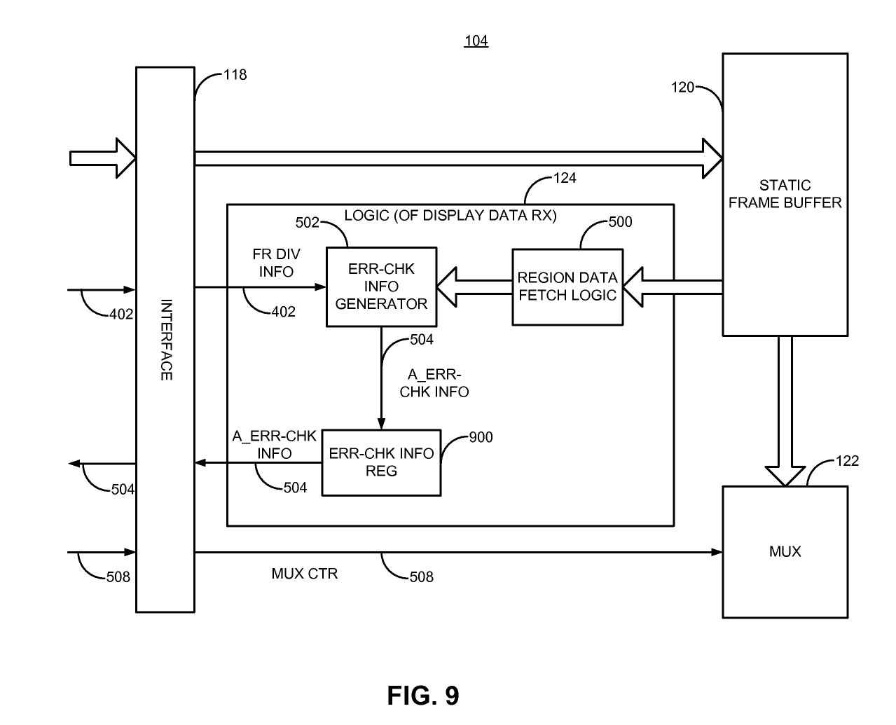

FIG. 9 is a block diagram illustrating another example of the display data receiver 104 of the apparatus 100 for providing a static frame when one or more regions of the static frame are altered due to data errors. Similar to the display data receiver 104 described above with respect to FIG. 5, in this example, the display data receiver 104 also includes the region data fetch logic 500 and the error-checking information generator 502. The display data receiver 104 in this example, however, does not include the error-checking information comparator 506. Instead, the display data receiver 104 may include an error-checking data register 900 operatively coupled to the error-checking information generator 502 and the interface 118. The error-checking information generator 502 is operative to store the actual error-checking information 504 in the error-checking information register 900. In response to a request from the display data transmitter 102, the actual error-checking information 504 is sent from the error-checking information register 900 to the display data transmitter 102 by the interface 118. In this example, as the display data receiver 104 does not include the error-checking information comparator 506, the outputting of the static frame is controlled by the MUX 122 in response to receiving the MUX control signal 508 from the display data transmitter 102.

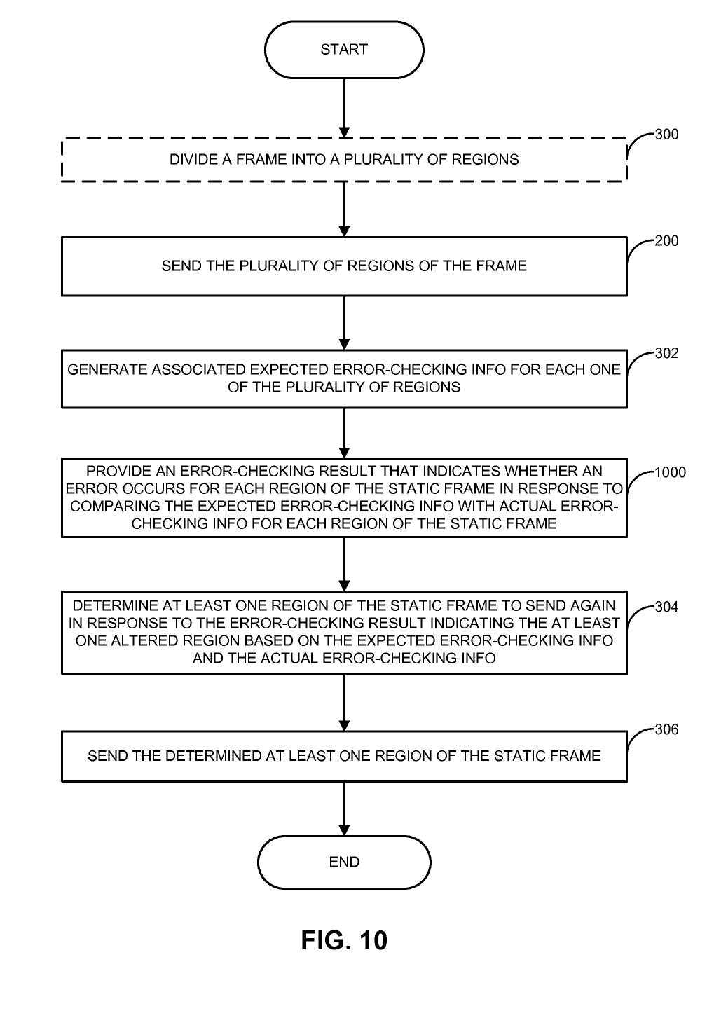

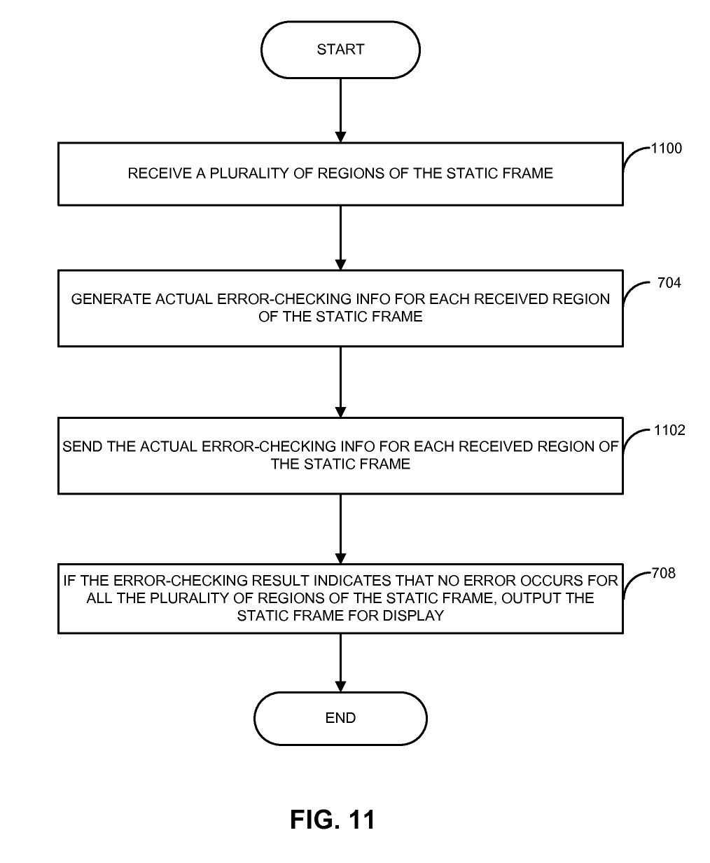

FIGS. 10 and 11 illustrate another example of a method for providing a static frame when one or more regions of the static frame are altered due to data errors. It will be described with reference to FIGS. 1, 8, and 9. However, any suitable logic or structure may be employed. In this example, the region based error-checking result is provided by the display data transmitter 102 as shown in FIG. 8. In operation, as shown in FIG. 10, the region data fetch logic 400 of the display data transmitter 102, at block 300, may divide a frame into a plurality of regions if necessary. At block 200, the region data fetch logic 400 controls the interface 114 to send the plurality of regions of the frame to the display data receiver 104. For example, when the apparatus 100 enters a self-refresh mode, the frame in the frame buffer 108 is a static frame, and the display data transmitter 102 sends all the regions of the first static frame to the display data receiver 104 for display. It is noted that, in this example, the expected error-checking information 406 is not sent to the display data receiver 104. The error-checking information generator 404 of the display data transmitter 102 then generates associated expected error-checking information 406 for each region at block 302

Now referring to FIG. 11, the interface 118 of the display data receiver 104 receives the plurality of regions of the static frame from the display data transmitter 102 at block 1100. The received regions may be stored in the static frame buffer 120 and fetched to the region data fetch logic 500. Proceeding to block 704, the error-checking information generator 502 of the display data receiver 104 generates the actual error-checking information 504 for each received region of the static frame using the same coding scheme (e.g., deterministic algorithm) for generating the expected error-checking information 406 at block 302. In this example, the regions are divided following a predefined rule that is known by the display data receiver 104, and thus, the frame divide information 402 is not necessary for generating the actual error-checking information 504. Otherwise, the frame divide information 402 is received from the display data transmitter 102 and is used for the generating process at block 704. Nevertheless, the generated actual error-checking information 504 is sent from the display data receiver 104 to the display data transmitter at block 1102.

Turning backing to FIG. 10, at block 1000, the error-checking information comparator 800 of the display data transmitter 102 receives the actual error-checking information 504 from the display data receiver 104 and provides the error-checking result 410 that indicates whether an error occurs for each region of the static frame in response to comparing the expected error-checking information 406 with the actual error-checking information 504 for each region of the static frame. Further to block 304, the region resend logic 408 of the display data transmitter 102 determines at least one region of the static frame to send again in response to the error-checking result 410 from the error-checking information comparator 800 of the display data transmitter 102 as the static frame region has been altered. At block 306, the region data fetch logic 400 controls the interface 114 to send the determined regions of the static frame to the display data receiver 104 to replace the corresponding altered regions stored in the static frame buffer 120.

It is understood that one or more processing blocks in FIGS. 10 and 11 may be performed again to determine whether all the data errors have been corrected after resending the regions. The process may finish if the error-checking result 410 indicates that no error occurs for all the plurality of regions of the static frame. Eventually, at block 708 in FIG. 11, the error-checking information comparator 506 of the display data transmitter 102 may send the MUX control signal 508 to the display data receiver 104 to control the MUX 122 to output the stored static frame to the display panel 106 for display.

Although the processing blocks illustrated in FIGS. 10 and 11 are illustrated in a particular order, those having ordinary skill in the art will appreciate that the processing can be performed in different orders. For example, block 200 can be performed after block 302 or performed essentially simultaneously. The logic 116 may send the plurality of regions of the static frame to the display data receiver 104 after generating the expected error-checking information 406 for each region if desired.

FIG. 12 is a block diagram illustrating another example of the apparatus 100 for providing a static frame when one or more regions of the static frame are altered due to updated content. The logic 116 of the display data transmitter 102 is operatively coupled to the frame buffer 108 and the interface 114 of the display data transmitter 102. The logic 116 in this example is operative to divide the frame in the frame buffer 108 into a plurality of regions. The logic 116 is also operative to detect at least one updated region of the plurality of regions of the static frame as the at least one altered region, wherein data is updated in the at least one updated region. The logic 116 is further operative to send the updated region of the static frame in response to the detection to the display data receiver 104.

For example, the logic 116 includes the region data fetch logic 400 operative to fetch a frame from the frame buffer 108 and divide the frame into a plurality of regions. The region data fetch logic 400 is operatively coupled to the interface 114 and is operative to control the interface 114 to send one or more regions of the frame to the display data receiver 104. In one example, when the apparatus 100 just enters the self-refresh mode, the region data fetch logic 400 may control the interface 114 to send all the regions of the first static frame to the display data receiver 104. In another example, during the self-refresh mode, the region data fetch logic 400 may control the interface 114 to send only the regions with updated content to the display data receiver 104.

In this example, the logic 116 includes a memory controller 1300 operatively coupled to the frame buffer 108 and the region data fetch logic 400. The memory controller 1300 is operative to continuously monitor each region of the static frame to determine if any data is updated in the region. In one example, a new static frame may be written into the frame buffer and cause the data of one or more regions of the previous static frame to update, and the write access may be detected by the memory controller 1300. In another example, movement of a mouse cursor may cause the data of one or more regions on the cursor moving path to update, and the change in cursor position coordinates may be detected by the memory controller 1300. The detection may be achieved by other techniques as known in the art.

In this example, the logic 116 also includes region update logic 1302 operatively coupled to the memory controller 1300, the region data fetch logic 400, and the interface 114. The region update logic 1302 is operative to receive the detection result from the memory controller 1300 and generate updated region identification information 1200 that identifies the one or more updated regions in the static frame based on the detection result. The region update logic 1302 is also operative to instruct the region data fetch logic 400 which one or more regions contain updated content and need to be resent to the display data receiver 104. The region update logic 1302 may be further operative to control the interface 114 to send the updated region identification information 1200 to the display data receiver 104 through the sideband channel 112 if necessary.

As to the display data receiver 104, it includes logic such as a region based static frame decoder 1304 operatively coupled to the static frame buffer 120 and the interface 118. The interface 118 of the display data receiver 104 is operative to receive the updated regions from the display data transmitter 102. In order to identify which one or more original regions stored in the static frame buffer 120 need to update and to determine the linkage between each received updated region with its corresponding original region stored in the static frame buffer 120, the interface 118 may be further operative to receive the updated region identification information 1200 from the display data transmitter 102. The region based static frame decoder 1304 is operative to identify the linkage between each received updated region with its corresponding original region stored in the static frame buffer 120 and to replace data in the original regions with data in the corresponding updated regions.

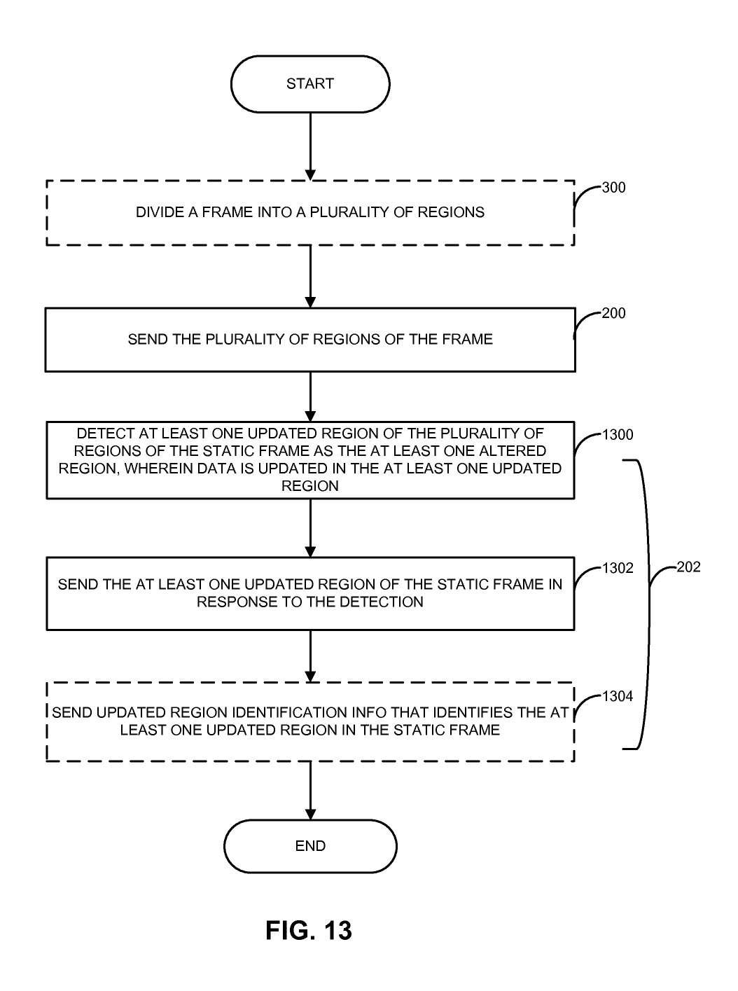

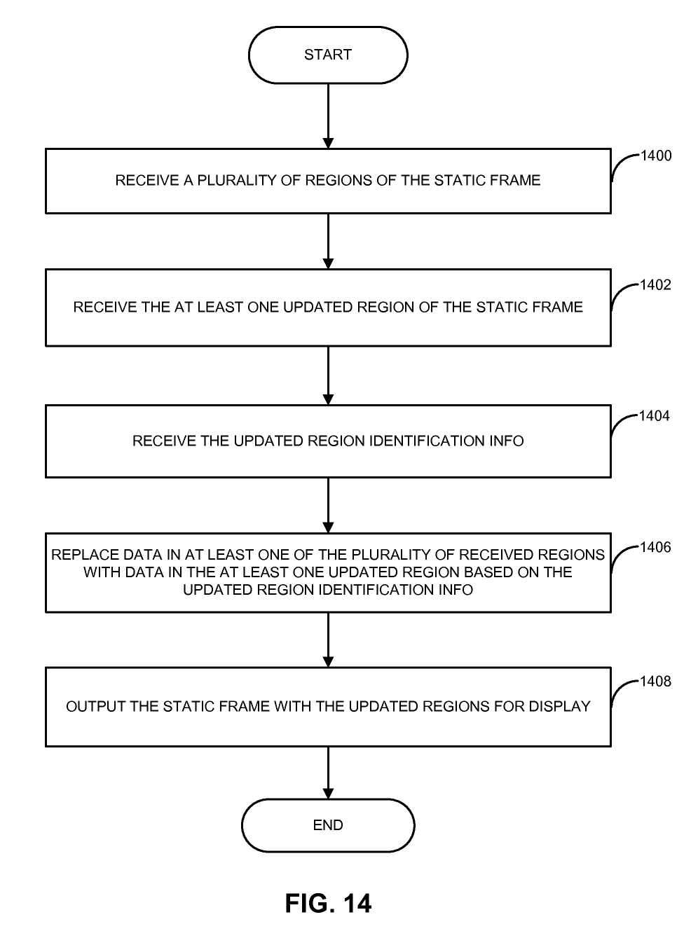

FIGS. 13 and 14 illustrate an example of a method for providing a static frame when one or more regions of the static frame are altered due to updated content. It will be described with reference to FIGS. 1 and 12. However, any suitable logic or structure may be employed. In operation, as shown in FIG. 13, the region data fetch logic 400 of the display data transmitter 102, at block 300, may divide a frame into a plurality of regions if necessary. At block 200, the region data fetch logic 400 then controls the interface 114 of the display data transmitter 102 to send the plurality of regions of the frame to the display data receiver 104 through the data channel 110. For example, when the apparatus 100 enters a self-refresh mode, the frame in the frame buffer 108 is a static frame, and the display data transmitter 102 sends all the regions of the first static frame to the display data receiver 104 for display.

Proceeding to block 1300, the memory controller 1300 detects at least one updated region of the plurality of regions of the static frame, wherein data is updated in the at least one updated region. The region update logic 1302 then identifies the update regions; and at block 1302, the region data fetch logic 400 controls the interface 114 to send the at least one updated region of the static frame. Optionally, the region update logic 1302 may generate the updated region identification information 1200 and control the interface 114 to send the updated region identification information 1200 to the display data receiver 104.

Referring to FIG. 14, the interface 118 of the display data receiver 104 receives the plurality of regions of a first static frame at block 1400 when the apparatus 100 just enters the self-refresh mode. The static frame is then stored in the static frame buffer 120, so that it can be repeatedly outputted to the display panel 106. In response to the detection of the display content being altered due to updated content by the display data transmitter 102, the interface 118 of the display data receiver 104 receives the at least one updated region of the static frame and the updated region identification information 1200 at block 1402 and 1404, respectively. Proceeding to block 1406, the region based static frame decoder 1304 replaces data of one or more stored original regions with data of the corresponding updated region based on the updated region identification information 1200. As a result, the static frame stored in the static frame buffer 120 is updated by replacing only the regions with the updated data, as opposed to replacing the entire static frame. At block 1408, the display data receiver 104 outputs the static frame with the updated regions to the display panel 106 for display.

Although the processing blocks illustrated in FIGS. 13 and 14 are illustrated in a particular order, those having ordinary skill in the art will appreciate that the processing can be performed in different orders. For example, block 1402 can be performed after block 1404 or performed essentially simultaneously. The interface 118 of the display data receiver 104 may simultaneously receive the updated regions of the static frame and the updated region identification information 1200 if desired.

Also, the logic described herein may be implemented as driver software stored on a computer readable medium such as but not limited to CDROM, RAM, other forms of ROM, hard drives, distributed memory, etc., in combination with processors. As such, driver software may be stored on computer readable medium. The computer readable medium stores instructions executable by one or more processors that causes the one or more processors to perform operations described herein.

Among other advantages, the method and apparatus provides the ability to reduce power consumption of a graphic processing and display system. Only the altered regions that contain data errors and/or updated content, as opposed to the complete static frame, need to be resent from the display data transmitter to the receiver in the self-refresh mode. Accordingly, the display data transmitter and receiver may further reduce their power consumption and enter the deep power saving mode faster compared with the known systems. In addition, the method and apparatus may perform the data error-checking by either the display data transmitter or by the display data receiver. The region based error-checking result is not limited to be provided at the transmitter side or at the receiver side, thereby increasing the design flexibility and compatibility for implementing such feature. Other advantages will be recognized by those of ordinary skill in the art.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. A method for providing a static frame comprising:
sending a plurality of regions of a frame; and
when the frame is static, sending at least one region of the frame corresponding to at least one altered region of the static frame.

2. The method of claim 1, wherein sending the at least one region of the frame comprises:
generating associated expected error-checking information for each one of the plurality of regions;
determining at least one region of the static frame to send again in response to an error-checking result indicating the at least one altered region based on the expected error-checking information and actual error-checking information; and
sending the determined at least one region of the static frame.

3. The method of claim 2, wherein sending the at least one region of the frame further comprises:
sending frame divide information that indicates a manner in which the static frame is divided into the plurality of regions.

4. The method of claim 2, wherein sending the plurality of regions of the frame comprises sending the plurality of regions of the frame with the associated expected error-checking information.

5. The method of claim 2 further comprising:
receiving the plurality of regions of the static frame; and
generating the actual error-checking information for each received region of the static frame.

6. The method of claim 5, wherein sending the at least one region of the frame further comprises providing an error-checking result that indicates whether an error occurs for each region of the static frame in response to comparing the expected error-checking information with the actual error-checking information for each region of the static frame.

7. The method of claim 6 further comprising, if the error-checking result indicates that no error occurs for all the plurality of regions of the static frame, outputting the static frame for display.

8. The method of claim 3, wherein the static frame is divided into a plurality of blocks; and wherein the frame divide information includes at least a start coordinate and a size of each block.

9. The method of claim 1, wherein sending the at least one region of the frame comprises:
detecting at least one updated region of the plurality of regions of the static frame as the at least one altered region, wherein data is updated in the at least one updated region; and
sending the at least one updated region of the static frame in response to the detection.

10. The method of claim 9, wherein sending the at least one region of the frame further comprises:
sending updated region identification information that identifies the at least one updated region in the static frame.

11. The method of claim 10 further comprising:
receiving the plurality of regions of the static frame;
receiving the at least one updated region of the static frame;
receiving the updated region identification information;
replacing data in at least one of the plurality of received regions with data in the at least one corresponding updated region based on the updated region identification information; and
outputting the static frame with the updated regions for display.

12. The method of claim 10, wherein the static frame is divided into a plurality of blocks; and wherein the updated region identification information includes at least a start coordinate and a size of each updated block.

13. An apparatus for providing a static frame comprising a display data transmitter comprising:
an interface; and
logic operatively coupled to the interface, operative to:
control the interface to send a plurality of regions of a frame; and
when the frame is static, control the interface to send at least one region of the frame corresponding to at least one altered region of the static frame.

14. The apparatus of claim 13, wherein the logic of the display data transmitter is operative to:
generate associated expected error-checking information for each one of the plurality of regions;
determine at least one region of the static frame to send again in response to an error-checking result indicating the at least one altered region based on the expected error-checking information and actual error-checking information; and
control the interface to send the determined at least one region of the static frame.

15. The apparatus of claim 14, wherein the logic of the display data transmitter is further operative to control the interface to send frame divide information, the frame divide information indicating a manner in which the static frame is divided into the plurality of regions.

16. The apparatus of claim 14 comprising a display data receiver operatively coupled to the display data transmitter, the display data receiver comprising:
an interface operative to receive the plurality of regions of the static frame from the display data transmitter; and
logic operatively coupled to the interface, operative to generate the actual error-checking information for each received region of the static frame.

17. The apparatus of claim 16,
wherein the logic of the display data transmitter is further operative to control the interface of the display data transmitter to send the plurality of regions of the frame with the associated expected error-checking information to the display data receiver; and
wherein the logic of the display data receiver is further operative to provide the error-checking result that indicates whether an error occurs for each region of the static frame in response to comparing the expected error-checking information with the actual error-checking information for each region of the static frame.

18. The apparatus of claim 16,
wherein the logic of the display data receiver is further operative to control the interface of the display data receiver to send the actual error-checking information for each region of the static frame to the display data transmitter; and
wherein the logic of the display data transmitter is further operative to provide the error-checking check result that indicates whether an error occurs for each region of the static frame in response to comparing the expected error-checking information with the actual error-checking information for each region of the static frame.

19. The apparatus of claim 16 further comprising a display panel operatively coupled to the display data receiver; and
wherein the display data receiver further comprises a multiplexer operatively coupled to the logic, the multiplexer operative to, if the error-checking result indicates that no error occurs for all the plurality of regions of the static frame, output the static frame to the display panel for display.

20. The apparatus of claim 13, wherein the logic of the display data transmitter is operative to:
detect at least one updated region of the plurality of regions of the static frame as the at least one altered region, wherein data is updated in the at least one updated region; and
control the interface to send the at least one updated region of the static frame in response to the detection.

21. The apparatus of claim 20, wherein the logic of the display data transmitter is further operative to control the interface to send updated region identification information that identifies the at least one updated region in the static frame.

22. The apparatus of claim 21 comprising a display data receiver operatively coupled to the display data transmitter, the display data receiver comprising:
an interface operative to:
receive the plurality of regions of the static frame from the display data transmitter;
receive the at least one updated region of the static frame from the display data transmitter; and
receive the updated region identification information from the display data transmitter; and
logic operatively coupled to the interface, operative to:
replace data in at least one of the plurality of received regions with data in the at least one corresponding updated region based on the updated region identification information; and
control outputting of the static frame with the updated regions for display.

23. A computer readable storage medium comprising executable instructions that when executed by one or more processors causes the one or more processors to:
send a plurality of regions of a frame; and
when the frame is static, send at least one region of the frame corresponding to at least one altered region of the static frame.

24. The computer readable storage medium of claim 23 further comprising executable instructions that when executed by one or more processors causes the one or more processors to:
generate associated expected error-checking information for each one of the plurality of regions;
determine at least one region of the static frame to send again in response to an error-checking result indicating the at least one altered region based on the expected error-checking information and actual error-checking information; and
send the determined at least one region of the static frame.

25. The computer readable storage medium of claim 23 further comprising executable instructions that when executed by one or more processors causes the one or more processors to:
detect at least one updated region of the plurality of regions of the static frame as the at least one altered region, wherein data is updated in the at least one updated region; and
send the at least one updated region of the static frame in response to the detection.
